(19) United States
(12) Patent Application Publication
(10) Pub. No.: US 2009/0225377 A1
(43) Pub. Date: Sep. 10, 2009

(54) IMAGE READING APPARATUS AND LIGHT SOURCE ARRANGEMENT METHOD

(76) Inventors: Shusaku Yokota, Ebina-shi (JP); Shiro Yamahashi, Ebina-shi (JP); Kaoru Takahashi, Ebina-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/326,428

(22) Filed: Dec. 2, 2008

(30) Foreign Application Priority Data
Mar. 4, 2008 (JP) 2008-52914

(51) Int. Cl. H04N 1/04

(52) U.S. Cl. 358/498; 358/474

(57) ABSTRACT

The image reading apparatus is provided with: a light source that is provided with a light-emitting face emitting light to a document, that has a width, and that is formed in a lengthy shape; and a light receiving part that receives light emitted from the light source and reflected from a read part where the document is to be read. The light source is arranged with inclination to the document, and a normal line from a center part of the light-emitting face in a width direction is directed to a part other than the read part.

### CROSS REFERENCE TO RELATED APPLICATIONS

This application is based on and claims priority under 35 USC §119 from Japanese Patent Application No. 2008-052914 filed Mar. 4, 2008.

### BACKGROUND

1. Technical Field

The present invention relates to an image reading apparatus that reads an image on a document, and a light source arrangement method.

2. Related Art

A document reading apparatus having a light source that irradiates a document linearly is known.

### SUMMARY

According to an aspect of the invention, there is provided an image reading apparatus including: a light source that is provided with a light-emitting face emitting light to a document, that has a width, and that is formed in a lengthy shape; and a light receiving part that receives light emitted from the light source and reflected from a read part where the document is to be read. The light source is arranged with inclination to the document, and a normal line from a center part of the light-emitting face in a width direction is directed to a part other than the read part.

### BRIEF DESCRIPTION OF THE DRAWINGS

Exemplary embodiment(s) of the present invention will be described in detail based on the following figures, wherein:

FIG. 1 is a diagram illustrating a configuration example of an image reading apparatus to which the present exemplary embodiment is applied;

FIGS. 2A and 2B are diagrams for explaining the first light source and the second light source;

FIGS. 3A to 3C are graphs in which the separate distance and the inclination angle are plotted when the light amount at the read part becomes the maximum as the separate distance and the inclination angle are changed; and

FIGS. 4A to 4C are graphs in which the separate distance and the inclination angle are plotted when the light amount at the read part becomes the maximum as the separate distance and the inclination angle are changed on the condition that the width of the first light source and the like is set at 3 mm.

### DETAILED DESCRIPTION

Hereinafter, a description will be given of exemplary embodiments of the present invention in detail with reference to attached drawings.

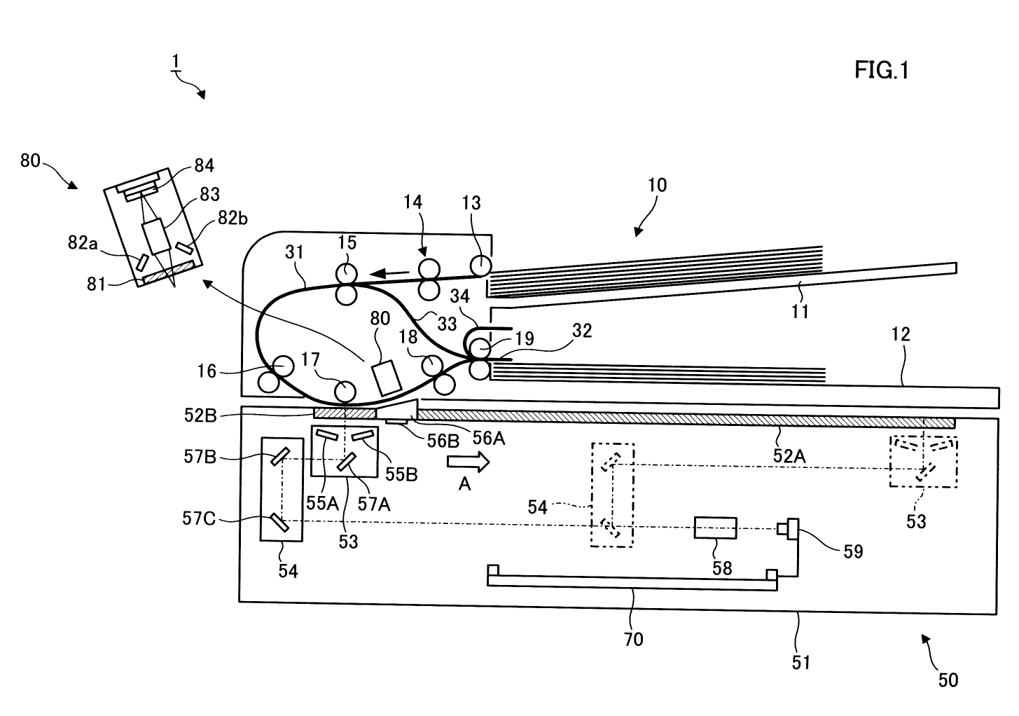

FIG. 1 is a diagram illustrating a configuration example of an image reading apparatus 1 to which the present exemplary embodiment is applied. With the image reading apparatus 1 shown in the figure, an image on a fixed document may be read and an image on a document being transported may also be read. The image reading apparatus 1 is provided with a document feeding device 10 that sequentially transports a document from a stacked bundle of documents and a reading device 50 that reads the image by scanning.

The document feeding device 10 that functions as one of the transporting units is provided with a document stacking part 11 that stacks a bundle of plural documents and an exit paper stacking part 12 that is provided below the document stacking part 11 and stacks the documents which have been read. In addition, the document feeding device 10 is provided with a nudger roll 13 that takes out and transports the documents in the document stacking part 11. Further, on the downstream side of the nudger roll 13 in the document transporting direction, a sorting mechanism 14 that sorts paper sheets one by one by a feed roll and a retard roll is provided. In a first transport path 31 on which the documents are transported, pre registration rolls 15, registration rolls 16, a platen roll 17, and out rolls 18 are provided in order from the upstream side in the document transporting direction. Moreover, inside the document feeding device 10, a Contact Image Sensor (CIS) unit 80 is provided.

The pre registration rolls 15 transport a document sorted one by one toward rolls on the downstream side while forming a loop of documents. The registration rolls 16 stop rotation once and then, resume the rotation at right timing and supply documents while performing registration adjustment to the document reading unit, which will be described later. The platen roll 17 assists transportation of the documents being read by the reading device 50. The out rolls 18 transport the documents read by the reading device 50 further to the downstream. In addition, on the downstream side of the out rolls 18 in the document transporting direction, a second transport path 32 that guides the documents to the exit paper stacking part 12 is provided. In the second transport path 32, exit rolls 19 are provided.

When the documents are transported by the document feeding device 10, a first face (one face) of the document is pressed onto a second platen glass 52B, and an image on the first face is read by a CCD image sensor 59 that is an example of a light receiving part. On the other hand, the CIS unit 80 reads an image on a second face (the other face) from the other opposite side across the first transport path 31.

Here, the CIS unit 80 is provided with a glass 81 arranged oppositely to the first transport path 31, and a first light source 82a and a second light source 82b that irradiate the second face of the document with a light going through the glass 81. In addition, a Selfoc lens (registered trademark) 83 focusing a reflected light from the document and a line sensor 84 (another example of the light receiving part) that reads the light focused by the Selfoc lens 83 are provided. As the line sensor 84, a CCD or CMOS (Complementary Metal Oxide Semiconductor) sensor, a contact image sensor and the like may be used. Note that, for the first light source 82a and the second light source 82b, an EL element, whose details will be described later, may be used. In the CIS unit 80, since an image is captured, not using a minification optical system but using a contact type optical system with the Selfoc lens 83 and the line sensor 84, the structure may be simplified, the size of a housing may be reduced and power consumption may be lowered.

Further, in the image reading apparatus 1, a third transport path 33 is provided between an outlet side of the out rolls 18 and an inlet side of the pre registration rolls 15 so that an image formed on both faces of the document may be read in one process. The above-mentioned exit rolls 19 have a function to reverse and transport the document to the third transport path 33.

Still further, in the image reading apparatus 1, a fourth transport path 34 is provided for reversing the document again and discharging the document to the exit paper stacking part 12 at discharge if the both faces of the document are read. The fourth transport path 34 is provided on an upper side of the second transport path 32. The above-mentioned exit rolls 19 further has a function to reverse and transport the document to the fourth transport path 34.

On the other hand, the reading device 50 supports the above-mentioned document feeding device 10 openably and closably, and supports the document feeding device 10 with a device frame 51, and further reads an image on a document transported by the document feeding device 10. The reading device 50 is provided with the device frame 51 forming a housing, a first platen glass 52A on which a document having an image to be read is placed in a stationary state, and the second platen glass 52B having an opening portion for light in order to read the document transported by the document feeding device 10. Here, the second platen glass 52B may be taken as a support part that has light permeability and supports the document.

In addition, the reading device 50 is provided with a full-rate carriage 53 that reads an image by staying below the second platen glass 52B or by scanning across the entire first platen glass 52A, and a half-rate carriage 54 that supplies a light obtained from the full-rate carriage 53 to an image forming part. Here, the full-rate carriage 53 is provided with a first light source 55A and a second light source 55B that irradiate the document with a light through the first platen glass 52A and the like.

Further, in the full-rate carriage 53, a first mirror 57A that reflects a reflected light obtained from the document is provided. Here, the first light source 55A is arranged on an upstream side of a light path from a read part, where the document is to be read, to the CCD image sensor 59 in a scan direction (upstream side in a slow scan direction), while the second light source 55B is arranged on a downstream side of the light path in the scan direction (downstream side in the slow scan direction). Moreover, in the half-rate carriage 54, a second mirror 57B and a third mirror 57C that provides light obtained from the first mirror 57A to the image forming part are provided.

In addition, the reading device 50 is provided with a driving source such as a motor and the like and is provided with a moving mechanism (not shown in the figure) that moves the half-rate carriage 54 and the full-rate carriage 53 in the slow scan direction. Further, the reading device 50 is provided with an image-forming lens 58 and the CCD image sensor 59. Among them, the image-forming lens 58 optically reduces an optical image obtained from the third mirror 57C. Furthermore, the CCD image sensor 59 photoelectrically converts an optical image formed by the image-forming lens 58. That is, in the reading device 50, an image is formed at the CCD image sensor 59 using a so-called minification optical system. Moreover, in the reading device 50, a guide 56A that guides a document transported in the document feeding device 10 is formed between the first platen glass 52A and the second platen glass 52B, and below the guide 56A, a white reference plate 56B extending along a fast scan direction is attached.

Further, the reading device 50 is provided with a control/image processing unit 70. The control/image processing unit 70 performs a processing to image data of the document inputted from the line sensor 84 provided in the CIS unit 80 and the CCD image sensor 59. Furthermore, the control/image processing unit 70 controls operations of each part in a reading operation of the image reading apparatus 1 (the document feeding device 10, the reading device 50, and the CIS unit 80). Note that, the first light source 55A, the second light source 55B, the CCD image sensor 59 and the like in the present exemplary embodiment may be taken as a reading unit that reads an image on the first face (front face) of the document.

Here, for example, if an image on the document placed on the first platen glass 52A is to be read, the full-rate carriage 53 and the half-rate carriage 54 move in the scan direction (arrow A direction) with a ratio of 2:1. At this time, the light is irradiated from the first light source 55A and the second light source 55B in the full-rate carriage 53 to the read part where the document is to be read. Then, the reflected light from the document is reflected at the first mirror 57A. After that, the reflected light is reflected by the second mirror 57B and the third mirror 57C in this order and guided to the image-forming lens 58. Thereafter, the light guided to the image-forming lens 58 forms an image on a light receiving face of the CCD image sensor 59. The CCD image sensor 59 is a one-dimensional sensor and processes one line at a time. When reading of the one line in the line direction (fast scan direction of the scan) is finished, the full-rate carriage 53 is moved to a direction orthogonal to the fast scan direction (slow scan direction) so as to read the subsequent line of the document. By executing the above operation across the entire document size, document reading of one page is completed.

On the other hand, if an image on the document transported by the document feeding device 10 is to be read, the document transported by the document feeding device 10 passes over the second platen glass 52B. At this time, the full-rate carriage 53 and the half-rate carriage 54 are in a stopped state at a solid-line position shown in FIG. 1. The reflected light of the first line of the document having passed the platen roll 17 of the document feeding device 10 is guided to the image-forming lens 58 via the first mirror 57A, the second mirror 57B, and the third mirror 57C.

Then, the reflected light forms an image at the image-forming lens 58, and the image is read by the CCD image sensor 59. After the one line in the fast scan direction is processed at a time by the CCD image sensor 59, which is a one-dimensional sensor, one subsequent line in the fast scan direction of the document transported by the document feeding device 10 is read. After that, by passage of a rear end of the document over a reading position of the second platen glass 52B, reading of one page across the slow scan direction is completed. Here, in the present exemplary embodiment, when the first face of the document is read by the CCD image sensor 59, the second face may also be read by the CIS unit 80 at the same time.

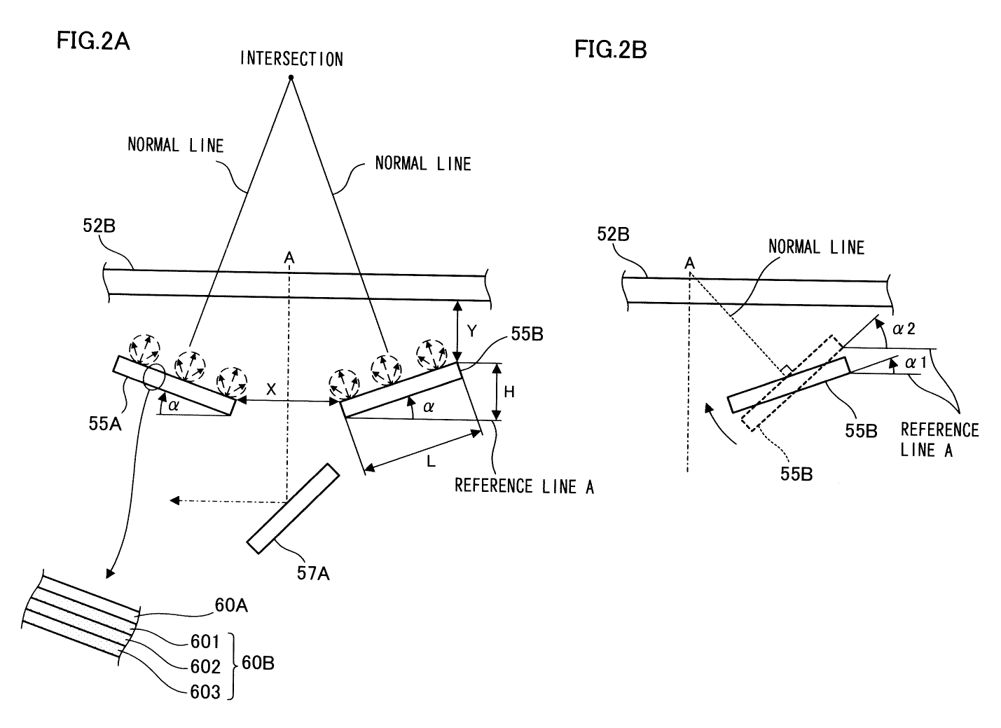

FIGS. 2A and 2B are diagrams for explaining the first light source 55A and the second light source 55B. In these figures, the full-rate carriage 53 is not shown.

The first light source 55A and the second light source 55B in the present exemplary embodiment are formed in a flat-plate shape and in a lengthy shape, and in addition, in a plane type. Further, each of the first light source 55A and the second light source 55B has a certain width L and is arranged along the fast scan direction. Furthermore, each of the first light source 55A and the second light source 55B is constituted by a so-called electro-luminescence lamp (EL lamp (EL element)) composed of a substrate 60A and a light emitting part 60B formed on the substrate 60A. Note that, the first light source 55A and the second light source 55B may be constituted using an existing art, and may be constituted by including a first electrode 601 arranged on the substrate 60A side and formed transparently and having light permeability, a second electrode 603 arranged at a position opposite to the first electrode 601, and a light-emitting layer 602 arranged between the first electrode 601 and the second electrode 603, for example. In the first light source 55A and the second light source 55B, light is emitted from the substrate 60A side. Thus, a surface of the substrate 60A may be taken as a light emitting face.

Here, the first light source 55A is arranged with inclination to the second platen glass 52B (document to be transported). In addition, the first light source 55A is arranged in an inclined state so that one end portion on the upstream side in the scan direction is closer to the second platen glass 52B than the other end portion on the downstream side in the scan direction. Explaining in more detail, the first light source 55A is arranged in an inclined state so that one side in a width direction is closer to the second platen glass 52B than the other side. Further, the second light source 55B is also arranged with inclination to the second platen glass 52B. In addition, the second light source 55B is arranged in an inclined state so that one end portion on the downstream side in the scan direction is closer to the second platen glass 52B than the other end portion on the upstream side in the scan direction. Explaining in more detail, the second light source 55B is arranged in an inclined state so that one side in the width direction is closer to the second platen glass 52B than the other side.

Here, each of the first light source 55A and the second light source 55B arranged with inclination is arranged in a state having an angle α with respect to a reference line A in parallel with the second platen glass 52B. Note that, the angle α corresponds to an alternate angle of an inclination angle of the first light source 55A and the second light source 55B with respect to the second platen glass 52B (document). Thus, the angle α may be taken as an inclination angle of the first light source 55A and the second light source 55B with respect to the second platen glass 52B (document). It should be noted that, in this specification, the angle α is hereinafter referred to as an inclination angle α.

Further, the first light source 55A and the second light source 55B are arranged with a distance X between them in the scan direction (slow scan direction). That is, the first light source 55A and the second light source 55B are arranged in a state of being separated from each other and having the distance X (hereinafter, the distance X between the first light source 55A and the second light source 55B is optionally referred to as a “separate distance X”). A light path to the CCD image sensor 59 is formed between the first light source 55A and the second light source 55B. Thus, the separate distance X is set at a length that may restrict interference between the light path and the first light source 55A and the like caused by vibration during scanning, manufacturing tolerance and the like. Note that, the present exemplary embodiment may be taken as a configuration in which the first light source 55A is arranged on one side relative to the light path and the second light source 55B is arranged on the other side relative to the light path. Furthermore, in the present exemplary embodiment, the first light source 55A and the second light source 55B are arranged in an axisymmetric relation with the light path as a symmetric axis.

Moreover, the first light source 55A and the second light source 55B are respectively arranged at positions having a distance Y from the second platen glass 52B. That is, the first light source 55A and the second light source 55B are each arranged to have the distance Y from the second platen glass 52B and to be separated from the second platen glass 52B (hereinafter the distance Y from the first light source 55A and the second light source 55B to the second platen glass 52B is optionally referred to as a “separate distance Y”).

The second platen glass 52B is affected by heat when the first light source 55A and the second light source 55B are lighted consecutively and the like, which might cause a crack. In addition, the first light source 55A and the second light source 55B might contact with the second platen glass 52B or the first platen glass 52A during scanning. Thus, it is preferable that the first light source 55A and the like and the second platen glass 52B and the like are arranged separately from each other as mentioned above. Further, the separate distance Y is preferably set at a length that may avoid the crack caused by heat generated from the second platen glass 52B or the contact between the second platen glass 52B and the like and the first light source 55A and the like.

In order to increase a light amount at the read part A, as in the second light source 55B shown by a broken line in the FIG. 2B, such a configuration may be adopted in which the second light source 55B is arranged so that a normal line, which is a normal line to the light emitting face of the second light source 55B and extends from the center part in the width direction (hereinafter referred to as a “center normal line”) is directed to the read part A.

However, according to a finding by a computer simulation by the inventor, it is confirmed that, rather than the above configuration, a configuration in which the second light source 55B is arranged so that the center normal line is directed to the parts other than the read part A increases the light amount at the read part A. In particular, it is confirmed that the light amount at the read part A is increased with a configuration in which the second light source 55B is arranged at an inclination angle α1 smaller than an inclination angle α2 when the second light source 55B is arranged so that the center normal line is directed to the read part A. In addition, it is confirmed that the light amount at the read part A is increased with a configuration in which the second light source 55B is arranged along the second platen glass 52B (document) rather than the second light source 55B arranged so that the center normal line is directed to the read part A.

A result of the simulation will be described below in detail.

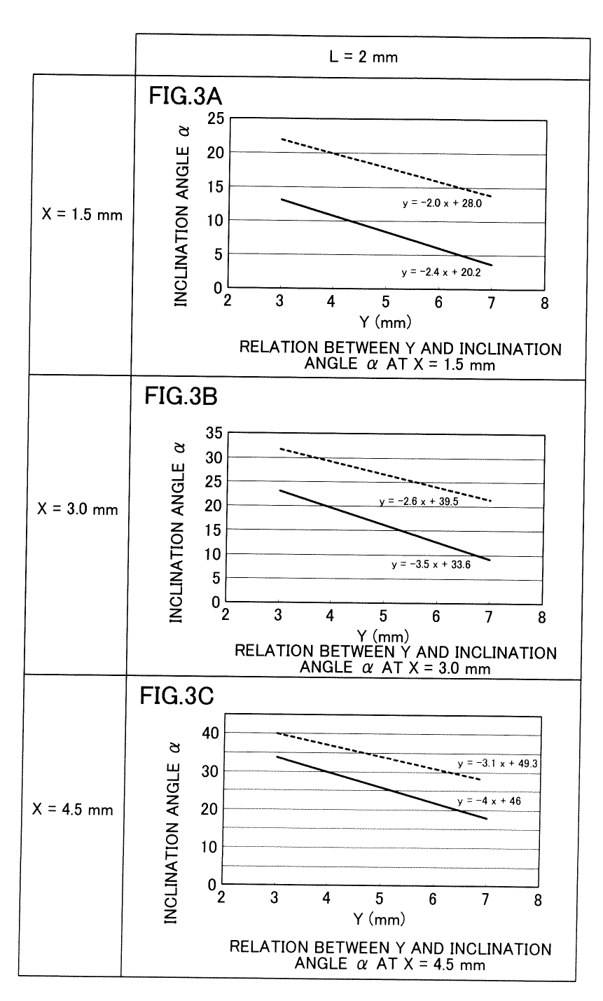

Here, FIGS. 3A to 3C are graphs in which the separate distance Y and the inclination angle α are plotted when the light amount at the read part A becomes the maximum as the separate distance Y and the inclination angle α are changed. In each of these figures, the separate distance Y and the inclination angle α, when the light amount becomes the maximum, are shown by a solid line. On the other hand, a relation between the separate distance Y and the inclination angle α when the first light source 55A and the second light source 55B are arranged so that the center normal line is directed to the read part A is shown by a broken line.

It should be noted that, FIG. 3A shows a result when the separate distance X is 1.5 mm, FIG. 3B shows a result when the separate distance X is 3.0 mm, and FIG. 3C shows a result when the separate distance X is 4.5 mm. In addition, the width L of the first light source 55A and the second light source 55B is 2 mm for each.

First, FIG. 3A will be explained. If the separate distance Y is 3 mm, for example, the inclination angle α of the first light source 55A and the like is 22° when the first light source 55A and the second light source 55B (hereinafter optionally referred to as “a first light source 55A and the like”) are arranged so that the center normal line is directed to the read part A. On the other hand, the inclination angle α of the first light source 55A and the like is 13° when the light amount at the read part A becomes the maximum. In addition, if the separate distance Y is 7 mm, for example, the inclination angle α of the first light source 55A and the like is 14° when the first light source 55A and the like are arranged so that the center normal line is directed to the read part A. On the other hand, the inclination angle α of the first light source 55A and the like is 3.4° when the light amount at the read part A becomes the maximum.

From the above results, it is found that, in order to maximize the light amount at the read part A, the first light source 55A and the like should be arranged at the inclination angle α smaller than the inclination angle α of the first light source 55A and the like arranged so that the center normal line is directed to the read part A.

Next, FIG. 3B will be explained. If the separate distance Y is 3 mm, for example, the inclination angle α of the first light source 55A and the like is 31.7° when the first light source 55A and the like are arranged so that the center normal line is directed to the read part A. On the other hand, the inclination angle α of the first light source 55A and the like is 23.1° when the light amount at the read part A becomes the maximum. In addition, if the separate distance Y is 7 mm, for example, the inclination angle α of the first light source 55A and the like is 21.3° when the first light source 55A and the like are arranged so that the center normal line is directed to the read part A. On the other hand, the inclination angle α of the first light source 55A and the like is 9.1° when the light amount at the read part A becomes the maximum. From the above results, it is also found that, in order to maximize the light amount at the read part A, the first light source 55A and the like should be arranged at the inclination angle α smaller than the inclination angle α of the first light source 55A and the like arranged so that the center normal line is directed to the read part A.

Further, FIG. 3C will be explained. If the separate distance Y is 3 mm, for example, the inclination angle α of the first light source 55A and the like is 40° when the first light source 55A and the like are arranged so that the center normal line is directed to the read part A. On the other hand, the inclination angle α of the first light source 55A and the like is 34° when the light amount at the read part A becomes the maximum. In addition, if the separate distance Y is 7 mm, for example, the inclination angle α of the first light source 55A and the like is 27.6° when the first light source 55A and the like are arranged so that the center normal line is directed to the read part A. On the other hand, the inclination angle α of the first light source 55A and the like is 18° when the light amount at the read part A becomes the maximum. From the above results, it is also found that, in order to maximize the light amount at the read part A, the first light source 55A and the like should be arranged at the inclination angle α smaller than the inclination angle α of the first light source 55A and the like arranged so that the center normal line is directed to the read part A.

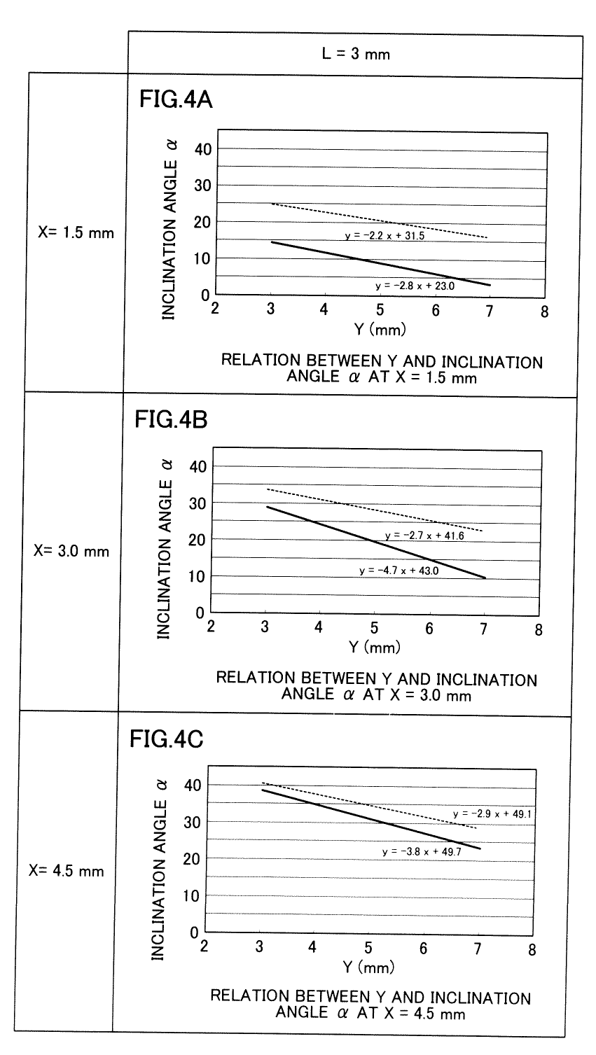

Next, FIGS. 4A to 4C will be explained. Here, FIGS. 4A to 4C are graphs in which the separate distance Y and the inclination angle α are plotted when the light amount at the read part A becomes the maximum as the separate distance Y and the inclination angle α are changed on the condition that the width L of the first light source 55A and the like is set at 3 mm. In each of these figures, the separate distance Y and the inclination angle α, when the light amount becomes the maximum, are shown by a solid line. On the other hand, a relation between the separate distance Y and the inclination angle α when the first light source 55A and the like are arranged so that the center normal line is directed to the read part A is shown by a broken line. It should be noted that, similarly to FIGS. 3A to 3C, FIG. 4A shows a result when the separate distance X is 1.5 mm, FIG. 4B shows a result when the separate distance X is 3.0 mm, and FIG. 4C shows a result when the separate distance X is 4.5 mm.

First, FIG. 4A will be explained. If the separate distance Y is 3 mm, for example, the inclination angle α of the first light source 55A and the like is 24.9° when the first light source 55A and the like are arranged so that the center normal line is directed to the read part A. On the other hand, the inclination angle α of the first light source 55A and the like is 14.6° when the light amount at the read part A becomes the maximum. In addition, if the separate distance Y is 7 mm, for example, the inclination angle α of the first light source 55A and the like is 16.1° when the first light source 55A and the like are arranged so that the center normal line is directed to the read part A. On the other hand, the inclination angle α of the first light source 55A and the like is 3.4° when the light amount at the read part A becomes the maximum. From the above results, it is also found that, in order to maximize the light amount at the read part A, the first light source 55A and the like should be arranged at the inclination angle α smaller than the inclination angle α of the first light source 55A and the like arranged so that the center normal line is directed to the read part A.

Next, FIG. 4B will be explained. If the separate distance Y is 3 mm, for example, the inclination angle α of the first light source 55A and the like is 33.5° when the first light source 55A and the like are arranged so that the center normal line is directed to the read part A. On the other hand, the inclination angle α of the first light source 55A and the like is 28.9° when the light amount at the read part A becomes the maximum. In addition, if the separate distance Y is 7 mm, for example, the inclination angle α of the first light source 55A and the like is 22.7° when the first light source 55A and the like are arranged so that the center normal line is directed to the read part A. On the other hand, the inclination angle α of the first light source 55A and the like is 10.1° when the light amount at the read part A becomes the maximum. From the above results, it is also found that, in order to maximize the light amount at the read part A, the first light source 55A and the like should be arranged at the inclination angle α smaller than the inclination angle α of the first light source 55A and the like arranged so that the center normal line is directed to the read part A.

Further, FIG. 4C will be explained. If the separate distance Y is 3 mm, for example, the inclination angle α of the first light source 55A and the like is 40.4° when the first light source 55A and the like are arranged so that the center normal line is directed to the read part A. On the other hand, the inclination angle α of the first light source 55A and the like is 38.3° when the light amount at the read part A becomes the maximum. In addition, if the separate distance Y is 7 mm, for example, the inclination angle α of the first light source 55A and the like is 28.8° when the first light source 55A and the like are arranged so that the center normal line is directed to the read part A. On the other hand, the inclination angle α of the first light source 55A and the like is 23.1° when the light amount at the read part A becomes the maximum. From the above results, it is also found that, in order to maximize the light amount at the read part A, the first light source 55A and the like should be arranged at the inclination angle α smaller than the inclination angle α of the first light source 55A and the like arranged so that the center normal line is directed to the read part A.

As mentioned above, when the first light source 55A and the like are arranged at the inclination angle α smaller than the inclination angle α of the first light source 55A and the like arranged so that the center normal line is directed to the read part A, the light amount at the read part A maybe increased. Note that, if the first light source 55A and the like are arranged at the inclination angle α smaller than the inclination angle α, an intersection (intersection position) between the center normal line of the first light source 55A and the center normal line of the second light source 55B is located at a part other than the read part A. Specifically, the intersection is located on the side far from the first light source 55A and the second light source 55B than the read part A (refer to FIG. 2A). Therefore, it may be recognized that the light amount at the read part A is increased if the intersection is arranged in a part other than the read part A (if the intersection is arranged on the side far from the first light source 55A and the second light source 55B than the read part A).

As a result, generation of a so-called cavity may also be reduced, for example. Here, the cavity refers to a phenomenon in which, if an image with high density is formed adjacently to the part to be read, for example, the light amount at the read part is lowered and the light amount of the light received by the CCD image sensor 59 is lowered.

If an image with high image density is formed adjacently to the read part, the irradiated light is absorbed by a part with high image density. The read part is irradiated with not only the light directly from the first light source 55A and the second light source 55B but also the light reflected at a part other than the read part. If an image with high image density is formed, light absorption occurs and the light amount of the reflected light is lowered, and thus, the light amount at the read part is lowered. In the present exemplary embodiment, since the light amount itself at the read part may be increased, even if an image with high image density is formed, the light amount at the read part may be ensured and generation of cavity may be reduced.

Further, if the separate distance Y in FIG. 3A is 3 mm, for example, a dimension H in a height direction of the first light source 55A and the like in the present exemplary embodiment (refer to FIG. 2A) is approximately 0.45 mm (L×sin α=2×sin 13°). On the other hand, the dimension H is 0.75 mm (L×sin α=2×sin 22°) when the first light source 55A and the like are arranged so that the center normal line is directed to the read part A.

Furthermore, if the separate distance Y in FIG. 4A is 3 mm, for example, the dimension H in a height direction of the first light source 55A and the like in the present exemplary embodiment is approximately 0.76 mm (L×sin α=3×sin 14.6°). On the other hand, the dimension H is approximately 1.26 mm (L×sin α=3×sin 24.9°) when the first light source 55A and the like are arranged so that the center normal line is directed to the read part A.

That is, in the arrangement configuration of the first light source 55A in the present exemplary embodiment, the dimension H of the first light source 55A and the like in the height direction may be made smaller than the arrangement configuration in which the first light source 55A and the like are arranged so that the center normal line is directed to the read part A. As a result, in the configuration in the present exemplary embodiment, the light amount at the read part A may be increased and an arrangement space for the first light source 55A and the like may be made smaller. That is, with the configuration in the present exemplary embodiment, both improvement of lighting efficiency and space saving are realizable.

In the above explanation, the case in which two light sources of the first light source 55A and the second light source 55B are used is explained. However, it is confirmed that the result similar to the above is also obtained only with either one of the light sources. That is, it is confirmed that even with either one of the light sources, the light amount at the read part A is increased as compared with the configuration in which the light source is arranged so that the center normal line is directed to the read part A.

In addition, in the present exemplary embodiment, the example in which the first light source 55A and the second light source 55B are provided in the full-rate carriage 53 is explained. However, the first light source 82a and the second light source 82b in the CIS unit 80 may also be arranged in the configuration of the present exemplary embodiment.

Further, the case with the separate distance Y of 3 mm or more is shown as a specific example in the above. However, it is confirmed that the result similar to the above is also obtained in the case where the separate distance Y is 0 mm or the separate distance Y exceeds 7 mm. Furthermore, the case where the width L of the first light source 55A and the like is 2 mm or 3 mm is explained as a specific example in the above, however, it is confirmed that the result similar to the above is also obtained in the case where the width L of the first light source 55A and the like exceeds 3 mm.

Moreover, in the present exemplary embodiment, the example in which the first light source 55A and the second light source 55B are arranged in the full-rate carriage 53 is explained. However, the first light source 55A and the second light source 55B exclusively used for light irradiation to transported documents may be provided on the back face of the second platen glass 52B. Further, to the transported document, light irradiation may be applied by using the exclusive first light source 55A and the second light source 55B, while, to the document placed on the first platen glass 52A, light irradiation may be applied by using the first light source 55A and the second light source 55B provided in the full-rate carriage 53. In this case, the first light source 55A and the second light source 55B provided on the back face of the second platen glass 52B may be arranged with the separate distance Y=0 as mentioned above. In addition, such arrangement may be made in which one side of each of the first light source 55A and the like in the width direction is brought into contact with the second platen glass 52B. In this case, the light amount at the read part A may further be increased.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading apparatus comprising:
a light source that is provided with a light-emitting face emitting light to a document, that has a width, and that is formed in a lengthy shape; and
a light receiving part that receives light emitted from the light source and reflected from a read part where the document is to be read,
the light source being arranged with inclination to the document, and a normal line from a center part of the light-emitting face in a width direction being directed to a part other than the read part.

2. The image reading apparatus according to claim 1, wherein the light source is arranged at an inclination angle with respect to the document, the inclination angle being smaller than an inclination angle set in a case where the normal line is directed to the read part.

3. The image reading apparatus according to claim 1, wherein the light source is constituted by an electro-luminescence element.

4. The image reading apparatus according to claim 1, further comprising a support part that has light permeability and supports the document, wherein
the light source is arranged so that one side in the width direction is in contact with the support part, and irradiates the document with light through the support part.

5. The image reading apparatus according to claim 1, further comprising:
a transporting unit that transports a document;
a support part that has light permeability and supports the document being transported by the transporting unit; and
a reading unit that reads an image on a first face of the document being transported, by irradiating the first face with light through the support part and receiving reflected light from the first face, wherein
the light source emits light to a second face of the document being transported and the light receiving part receives reflected light from the second face of the document.

6. An image reading apparatus comprising:
a light receiving part that receives reflected light from a read part where a document is to be read;
a first light source that is provided on one side relative to a light path of the reflected light and is provided with a light-emitting face emitting light to the document; and
a second light source that is provided on the other side relative to the light path of the reflected light and is provided with a light-emitting face emitting light to the document, wherein
the first light source and the second light source are arranged so that an intersection position of a normal line from a center part of the light-emitting face in a width direction in the first light source and a normal line from a center part of the light-emitting face in a width direction in the second light source is located at a part other than the read part.

7. The image reading apparatus according to claim 6, wherein the first light source and the second light source are each arranged at an inclination angle with respect to the document, the inclination angle being smaller than an inclination angle set in a case where the normal line is directed to the read part.

8. The image reading apparatus according to claim 6, wherein the first light source and the second light source are arranged so that the intersection position is located on a side far from the first light source and the second light source than the read part.

9. The image reading apparatus according to claim 6, wherein the first light source and the second light source are arranged in an axisymmetric relation with respect to the light path of the reflected light, as a symmetric axis.

10. A light source arrangement method of an image reading apparatus including a light source that is provided with a light-emitting face emitting light to a document, that has a width, and that is formed in a lengthy shape, and a light receiving part that receives light emitted from the light source and reflected from a read part where the document is to be read, the light source arrangement method comprising:
arranging the light source with inclination to the document, and directing a normal line from a center part of the light-emitting face in a width direction to a part other than the read part.

11. The light source arrangement method according to claim 10, further comprising arranging the light source at an inclination angle with respect to the document, the inclination angle being smaller than an inclination angle set in a case where the normal line is directed to the read part.

12. The light source arrangement method according to claim 10, wherein the light source is constituted by an electro-luminescence element.
